(19) United States
(12) Patent Application Publication
(10) Pub. No.: US 2004/0059739 A1
(43) Pub. Date: Mar. 25, 2004

(54) Online IC package searching system

(76) Inventors: I-Linag Lin, Tainan City (TW); Sung-Mao Wu, Kaohsiung (TW)

Correspondence Address: BIRCH STEWART KOLASCH & BIRCH, PO BOX 747, FALLS CHURCH, VA, 22040-0747, US

(21) Appl. No.: 10/640,301

(22) Filed: Aug. 14, 2003

(30) Foreign Application Priority Data
Sep. 19, 2002 (TW) 091121519

(51) Int. Cl. G06F 17/00

(52) U.S. Cl. 707/100

(57) ABSTRACT

An on-line IC package searching system comprises a processing controller to process parameters sent by a user via a network, wherein the parameters comprises a user information and a package information. A database is coupled to the processing controller to store package information. An entrust system is coupled to the processing controller to analyze the parameters input by the user that that does not exist in the database. A plurality of analyzing modules is coupled to the entrust system to analyze the parameters input by the user. A report generator is coupled to the entrust system for generating a report. A replying means responsive to the report generator to forward the report to the user.

### BACKGROUND OF THE INVENTION

1.Field of the Invention

The present invention relates to a system for automatically providing preliminary testing parameters of IC package to the customer via a communication network, and more specifically, to a system for automatically replying the testing result to the customer and analyzing the parameters of the package.

2. Description of the Prior Art

Modern network systems must allow computers to electronically communicate with each other in order to ensure shared transmission and manipulation of information. The E-Commerce becomes the trend for transaction. Conventional commerce involves a salesman using a telephone and a facsimile machine to negotiate a sale with a customer. In addition to spending a significant amount of time, the conventional method of commerce is slow, time-intensive and expensive to initiate and maintain. Rapid development of the Internet has enabled computer systems to provide an efficient, widely accessible, and secure mechanism for conducting electronic commerce. By connecting most computer systems worldwide, the network allows users to interact using various services such as electronic mail and the World Wide Web (WWW). The WWW uses the HTTP protocol. Currently, a Hyper Text Markup Language (“HTML”) file defines a web page. A browser refers to the software on a client computer that manages the Internet connections and interprets as well as executes the commands in HTML documents. Some systems have been invented in the past to provide the service via internet including the system for matching the sellers and the buyers, the good shopping and so on.

When the engineer encapsulates the IC package, he must consider the parameters for packing the die and follows the trend of making the devices with the high-speed, small size. The conductive traces of the package have to be as shorter as better and the package includes a perfect protection structure for the ground system. On the other hand, the large-scale system has more electrical parasites, thereby reducing the signal transmission. Thus, there is a need to have a package database for the engineer to fetch the relating information.

### SUMMARY OF THE INVENTION

Base on the previous discussion, the object of the present invention is to provide a system for automatically providing preliminary testing parameters of IC package to the customer via a communication network, and more specifically, to a system for automatically replying the testing result to the customer and analyzing the parameters of the package.

An on-line package searching system comprises a processing controller to process parameters sent by a user via a network, wherein the parameters comprises a user information and a package information. A database is coupled to the processing controller to store package information. An entrust system is coupled to the processing controller to analyze the parameters input by the user that that does not exist in the database. A plurality of analyzing modules is coupled to the entrust system to analyze the parameters input by the user. A report generator is coupled to the entrust system for generating a report. A replying means responsive to the report generator to forward the report to the user.

The user communicates with the on-line package searching system via an internet interface. The processing controller searches the database depending on the parameters input by the user and sent the results to the report generator. Wherein if the searching failed, the report generator will inform the user that the searching failed and will ask whether the user would like to analyze the parameters input by the user or not. If the answer is positive, the on-line package searching system will drive the entrust system to analyze the input parameters by the analyzing modules. The entrust system sends the report to the report generator and the processing controller stores the report in the database. A plurality of analyzing modules includes an electrical analyzing module.

The present invention also disclosed a method for automatically providing on-line package searching comprises:

inputting parameters relating to a semiconductor package by a user;

searching relating information in a database by a processing controller;

if there is a matched information in the database, then sending the matched information to a report generator to create report for the user, otherwise, asking whether the user would like to analyze the parameters;

sending the report to a replying means;

if the user decides to analyze the parameters, then sending the parameters to an entrust system;

analyzing the parameters by a plurality of analyzing modules;

gathering analyzed result by the entrust system;

sending the gathered analyzed result to the report generator and storing the gathered analyzed result in the database; and

sending a report having the gathered analyzed result to a replying means for informing the gathered analyzed result to the user.

### BRIEF DESCRIPTION OF THE DRAWINGS

FIG. 1 is a functional diagram of the system according to the present invention; and

FIG. 2 is a flow chart diagram according to the present invention.

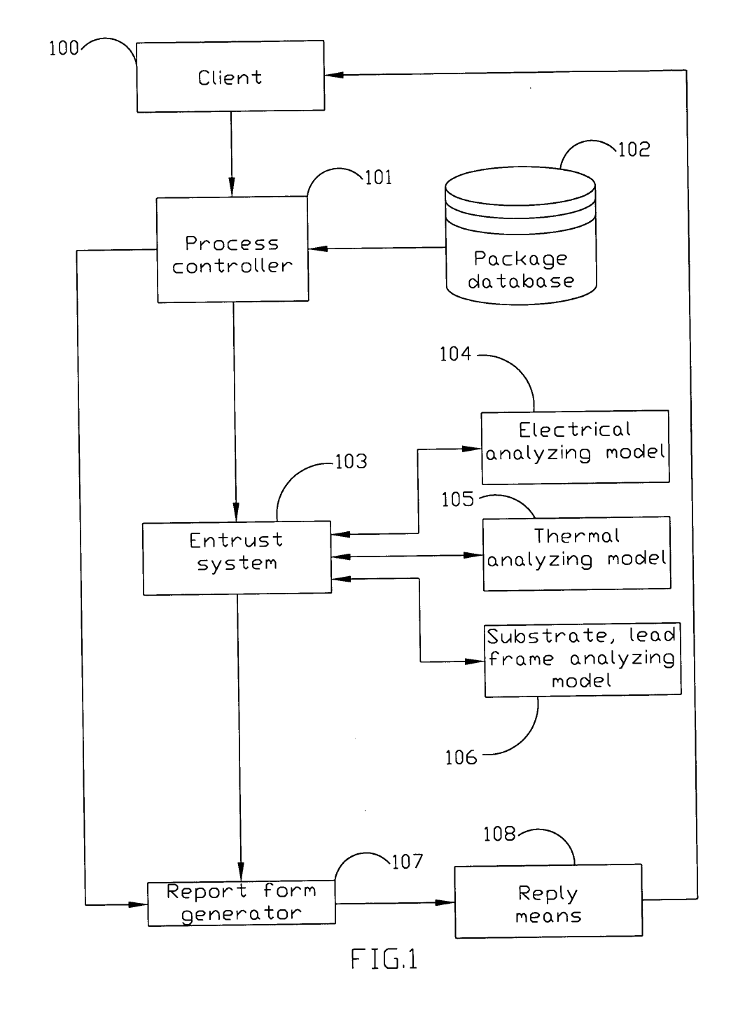

### DESCRIPTION OF THE PREFERERED EMBODIMENT

The present invention discloses a system that provides the IC package parameters to the user 100 when a plurality of parameters have been input and be sent to the processing controller 101 via an internet. Therefore, the user 100 may fetch the searching result depending on the query conditions of the user 100 via a communication network.

The user may select one or more package type via the communication interface then the processing unit 101 transmits the information to report generator 107. The selected information will also be stored in the database for calculation. The report generator 107 creates the query report followed by replying the report to the means for replying 108. The replying means will send the query report to the client 100 by e-mail or the like. The e-mail system is used for example, not used to limit the scope of the present invention.

In addition, if the query information does not exist in the system, the report generator 107 will inform the user that the searching failed and would the user to analyze the package parameters input by the user 100. If the answer is positive, the system will drive the entrust system 103 to analyze the input data by the analyzing modules. The user 100 may click the hyperlink item on the electronic format report or by e-mail.

The entrust system 103 performs the mission and send the relating information to a plurality of analyzing modules for analyzing the information of the IC packages. The plurality of analyzing modules include but not limited to the electrical analyzing module 104, the spreading-heat analyzing module 105, and the lead frame analyzing module 106. The user may select one or more analyzing modules for analyzing the information of the IC packages. The analyzing result will be fed to the entrust system 103 and the system 103 collects all the analyzing results followed by sending to the report generator 107. The report generator 107 has the dual functions of replying report and generating report, it also could be formed by two individual units.

Then, the collected data is fed to the replying means 108 by the report generator 107 via communication network. The entrust system 103 not only sends the information to the report generator 107, but also the processing controller 101.

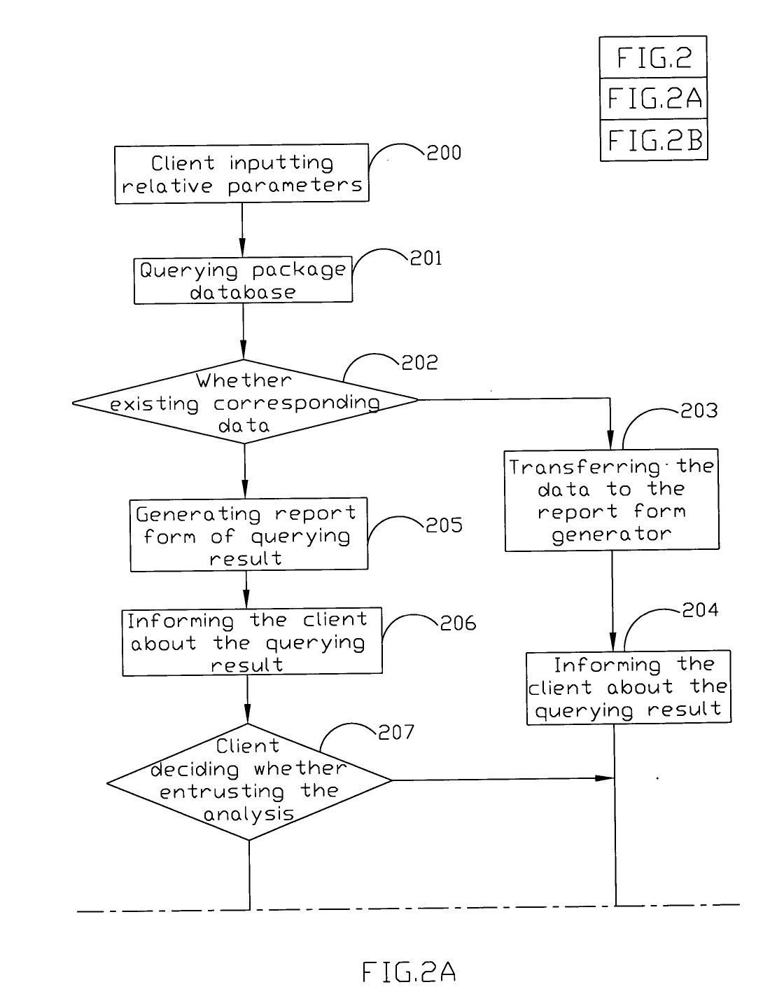

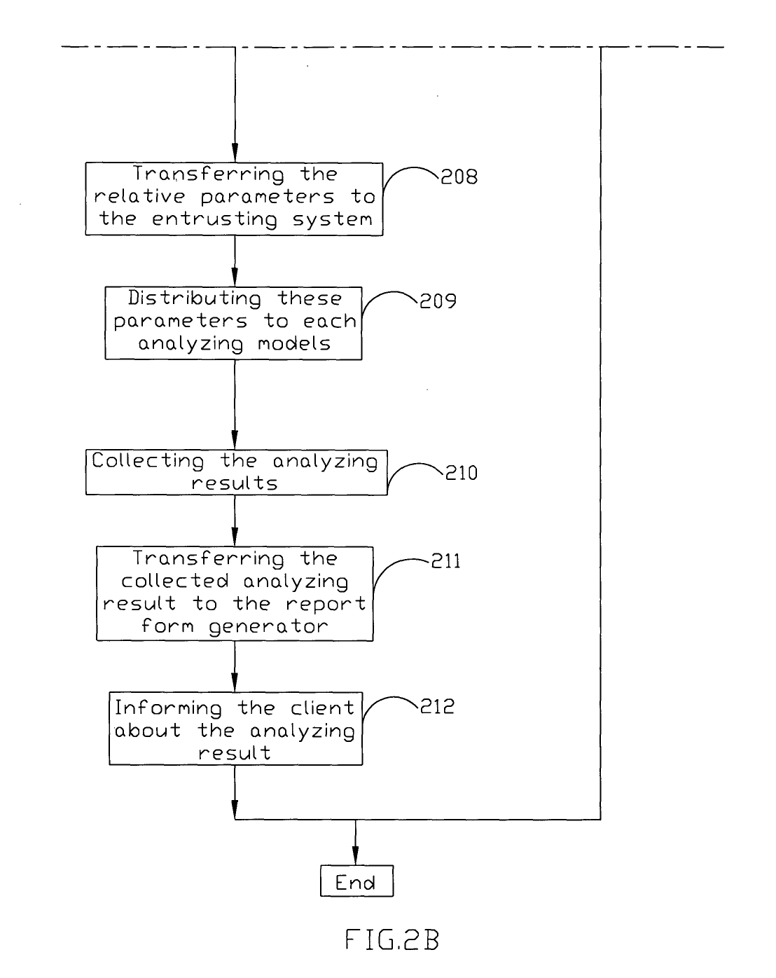

FIG. 2 is a flow chart that consists of FIG. 2A and FIG. 2B in accordance with the present invention. The user 100 may login the system and the user input the data for query information, step 200. Step 201, the processing controller 101 receives the query information, then the processing controller 101 searching the database to find the matched information in the step 202. If there is the searched information, then the IC package information will be sent to the report generator 107 to create the searching report in step 203. If the searching can not find the matched information, then the report generator 107 will inform the user that the searching failed and make sure whether the user would like to analyze the package parameters or not (205). The report generator 107 creates the query report followed by replying the report to the means for replying 108. The replying means will send the query report to the client 100 by e-mail or the like, steps 204, 205. The e-mail system is used for example, not used to limit the scope of the present invention.

If the user does not want to have an advance analysis, the searching is finished. Otherwise (step 207), the processing controller 101 drives the entrust system 103 to analyze the input data by the analyzing modules. The entrust system 103 analyzes the input data at least by the electrical analyzing module 104, the spreading-heat analyzing module 105, and the lead frame analyzing module 106. The user may select one or more analyzing modules for analyzing the information of the IC packages.

The analyzing result will be fed to the entrust system 103 and the system 103 gathers the results in step 210. Subsequently, The entrust system 103 sends the results to the report generator 107 and the on-line searching system stores the in the database to increase the information of the system (211). Then, the collected data is fed to the replying means 108 by the report generator 107 via communication network. The results are finally sent to the user 100 in step 212 by the system via the e-mail, facsimile or the like. Wherein the searching result includes more information matched to the query requested by the user, the user may be selected one or more of the information such as said selected information will be included in the report.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. Thus, while the preferred embodiment of the invention has been illustrated and described, it will be appreciated that various changes can be made therein without departing from the spirit and scope of the invention.

The embodiments of the invention in which an exclusive property or privilege is claimed are defined as follows:

1. An on-line package searching system comprises:
a processing controller to process parameters sent by a user via a network, wherein said parameters comprises a user information and a package information;
a database coupled to said processing controller to store a package information;
an entrust system coupled to said processing controller to analyze said parameters input by said user that that does not exist in said database; and
a plurality of analyzing modules coupled to said entrust system to analyze said parameters input by said user;
a report generator coupled to said entrust system for generating a report; and
a replying means responsive to said report generator to forward said report to said user.

2. The system of claim 1, wherein said user communicates with said on-line package searching system via an internet interface.

3. The system of claim 1, wherein said processing controller searches said database depending on said parameters input by said user and sent said results to said report generator.

4. The system of claim 1, wherein said searching failed, said report generator will inform said user that said searching failed and will ask whether said user would like to analyze said parameters input by said user or not, if the answer is positive, said on-line package searching system will drive said entrust system to analyze the input parameters.

5. The system of claim 1, wherein said entrust system sends said report to said report generator and said processing controller stores said report in said database.

6. The system of claim 1, wherein said analyzing modules include an electrical analyzing module.

7. The system of claim 1, wherein said analyzing modules include a spreading-heat analyzing module.

8. The system of claim 1, wherein said analyzing modules include a lead-frame, substrate analyzing module.

9. The system of claim 1, wherein said replying means replies said report to said user by e-mail, and facsimile, or composition of above both or either.

10. The system of claim 1, wherein said entrust system gathers the result analyzed by said plurality of analyzing modules.

11. The system of claim 1, wherein said database stores the record of the success searching.

12. A method for automatically providing on-line package searching comprises:
inputting parameters relating to a semiconductor package by a user;
searching relating information in a database by a processing controller;
if there is a matched information in said database, then sending said matched information to a report generator to create report for said user, otherwise, asking whether said user would like to analyze said parameters;
sending said report to a replying means;
if said user decides to analyze said parameters, then sending said parameters to an entrust system;
analyzing said parameters by a plurality of analyzing modules;
gathering analyzed result by said entrust system;
sending said gathered analyzed result to said report generator and storing said gathered analyzed result in said database; and
sending a report having said gathered analyzed result to a replying means for informing said gathered analyzed result to said user.

13. The method of claim 12, wherein said user communication with said on-line package searching system via an internet interface.

14. The method of claim 12, wherein said database records successful reaching information therein.

15. The method of claim 12, wherein said plurality of analyzing modules includes an electrical analyzing module.

16. The method of claim 12, wherein said plurality of analyzing modules includes a spreading-heat analyzing module.

17. The method of claim 12, wherein said plurality of analyzing modules includes a lead-frame, substrate analyzing module.

18. The method of claim 12, wherein said replying means replies said report to said user by e-mail, and facsimile, or composition of above both or either.

19. The method of claim 12, wherein said searching result includes more information matched to the query requested by said user, said user may selected one or more of said information such as said selected information will be included in said report.
